(19) United States
(12) Patent Application Publication
(10) Pub. No.: US 2011/0121019 A1
(43) Pub. Date: May 26, 2011

(54) Device for Drug Distribution and Method of Using Thereof

(75) Inventors: Mordechai Peer, Kokhav Ya'ir (IL); Ofer Baram, Tel Aviv (IL); Ran Frenkel, Yehud-Monosson (IL)

(73) Assignee: 2P2D SOLUTIONS LTD., Kiryat Arba (IL)

(21) Appl. No.: 13/003,394

(22) PCT Filed: Jul. 9, 2009
(86) PCT No.: PCT/IL2009/000689

§ 371 Date: Jan. 10, 2011

Related U.S. Application Data
(60) Provisional application No. 61/079,462, filed on Jul. 10, 2008.

(51) Int. Cl. B67D 7/08; B65D 83/04

(52) U.S. Cl. 222/1; 222/81; 206/531

(57) ABSTRACT

A medicament dispensing device comprises (a) at least one container adapted for accommodating and dispensing at least one elongate packagible elongate blister pack carrying a plurality of blisters containing the medicament; (b) transporting means adapted for transporting the blister pack toward opening of the container; (c) dispensing means adapted for releasing a fragment of the blister pack bearing a predetermined number of the blisters from the container through the opening to a patient; and (d) controlling means adapted for identifying the patient before dispensing the blister to the patient, activating the dispensing means, recording actions of dispensing. The substrate is foldable and configured to be folded within the container. The dispensing means is adapted to cut off the blister bearing fragment. The dispensing means adapted to cut off the blister bearing fragment such that the blisters remain intact.

### FIELD OF THE INVENTION

The field of the invention relates to a device for pill medication dispensing to patients, more specifically, a pill dispensing device adapted for procuring medication compliance by patients in the clinical trials.

### BACKGROUND OF THE INVENTION

Drug regimen compliance is defined as: the degree of correspondence between actual dosing history and the prescribed regimen. This means that the administration/intake of a correct dose of the drug must take place at a defined time of intake, and the patient will continue in doing so for the whole period of treatment. Perhaps the most critical point for measuring patient compliance is during the clinical research trials used to determine the efficacy of new pharmaceuticals. On the basis of the results of such trials, new medications are either licensed for general medical use or abandoned. Clinical trials data also determine the recommended dosing strategies for specific clinical indications. Consequently, inaccurate data during clinical trials can result in decisions that will affect everyone who uses the drug during its lifetime—tens of millions of patients in the case of widely used drugs. It can also result in a potentially therapeutic drug being unnecessarily abandoned.

Best practice guidelines in clinical pharmacotherapy are designed to maximize the therapeutic effect of medications while minimizing side effects and cost. The dose, dosing interval, and duration of pharmacotherapy are based on the best estimate of the time during which a therapeutic plasma level will achieve the desired therapeutic effect. New medications are tested clinically on patients having the disease of interest, and the outcome contributes significantly to the best practice guidelines. Patient compliance with the dosing regimen during clinical trials is critical to establishing accurate dosing guidelines.

In a clinical trial, poorly compliant patients may require an average of 10 days to cure; perfectly compliant patients only five days. However, due to individual differences, some poorly compliant patients may need 12 days of therapy and some perfectly compliant patients may require only three days. The ensuing best practice guidelines must ensure that all patients being treated will be cured. Thus, physicians prescribing the drug for the rest of its life will prescribe it for 10 days for everyone although for compliant patients only five days are necessary. If the physician knew a patient was perfectly compliant, he or she could prescribe a five-day course of the antibiotic with confidence.

Conversely, if a non compliant patient did not respond to the antibiotic the prescribing physician might educate the patient and continue the same antibiotic rather than assuming the drug is resistant and changing to another antibiotic. In both scenarios, knowledge of the patient's compliance would have positive implications for health care at the macro level.

Patient diary is one tool often used. The patient has to state time of administration immediately as it occurs. However, data from a diary is at least questionable. There is a very high discrepancy between patient-reported events (as intake) and the actual access to the diary, which was monitored by means of a timer hidden in a cover for a paper diary. The term “car park compliance” and “white coat compliance” (poor or partial compliers improving their compliance around the time of scheduled following visits) are important notions, which must be taken seriously, because investigators might reach incorrect conclusion with respect to effects caused by noncompliance or by the test drug itself. Also, “white coat compliance” pattern makes therapeutic drug monitoring a potential unreliable tool for long-term drug exposure. The most widely used techniques for monitoring compliance with medication are pill counts and medication diaries. These are used in most clinical pharmaceutical trials, and rarely in clinical settings. The former technique involves counting the number of pills returned to the study monitor at the end of an interval and checking to see if this is congruent with compliance. In the latter, patients keep a diary of their medication-taking and may also record side effects, clinical response, and other events of interest.

The data can then be used to assess compliance and, if desired, target education to non-compliant patients. Unfortunately, both have been demonstrated to be ineffective. Patients are prone to filling out diaries retrospectively just before meeting with the study monitor or “adjusting” their medication to compensate for missed doses. Neither pill counts nor medication diaries address the issue of patients not taking their medication on schedule. Yet, despite their limitations, these techniques remain the industry standard. The electronic monitoring methods, i.e. time and date stamping micro circuitry incorporated into drug packages, provide a continuous record of timing of presumptive doses throughout periods of many months, but do not prove dose ingestion. The electronic record has been judged robust enough to detect certain types of investigator fraud, and to support modeling projections of the complete time course of the plasma drug concentration during a trial. Both marker and electronic methods show that the predominant errors are those of omission, i.e. delays or omissions of scheduled doses. Patient interviews, diaries, and counts of returned, untaken doses have been shown by both marker and electronic monitoring methods to consistently and substantially to overestimate compliance. Monitoring of plasma drug concentrations also overestimates compliance; because white-coat compliance is prevalent, and the pharmacokinetic turnover of most drugs is rapid enough that measured concentrations of drug in plasma reflect only drug administration during the period of white-coat compliance. Thus, compliance is a great deal poorer in clinical trials than has been revealed by the older methods. The long-standing underestimation of poor compliance in drug trials has many implications for the interpretation of drug trials, for optimal dose estimation, for the interpretation of failed drug therapy, and for accurate labeling of prescription drugs. The introduction of radiofrequency identification device, RFID tags-enabled computer chip technology has introduced the possibility of monitoring that a patient has taken medication, and when the medication was taken. It is evident that pharmaceutical products-even within identical indication-differ widely in the degree of compliance needed in their dosing schedules.

Focusing on the financial and human costs associated with medication non-compliance, Information Mediary Corporation has developed the Med-ic™ ECM™ Package, an electronic device that provides precise inventory monitoring in clinical settings for blister—packaged medication. The use of electronic compliance packaging continues to grow, with two recently launched products joining the fray. MeadWestvaco Healthcare Packaging (Mebane, N.C.) has begun initial testing of Cerepak, an electronic update Dosepak package. Information Mediary Corp. (IMC; Ottawa, ON, Canada), meanwhile, is currently testing the Med-ic ECM blister package. Cerepak employs smart technology to measure and improve patient compliance. It reminds patients when to take medication, records when they do, and reports that data back to their doctor or pharmacist. The package's built-in ‘brain’ also provides real-time compliance measurement that can expedite drug development through clinical trials, enhance patient persistence, and improve the bottom line. The technology allows the removal of each pill from a blister package. When a pill is removed, the package emits a slight beeping noise, recording the time and date of removal of medication. It also records which pill has been taken. In addition, a patient questionnaire is integrated into the package, featuring a log for patient side effects and time to onset. The questionnaire also measures pain and nausea. IMC's Medic is also currently being tested in clinical settings. The package uses an electronic device that is integrated into a blister package. It tracks medication usage without active patient input and contains an RFID smart tag that records the time at which the tablet or capsule is expelled, logging the patient's medication use. Following completion of a clinical trial, the patient can return the blister package to a clinician, who uses the RFID scanner to download the information into a database. The data are downloaded through a 13.56-MHz RF wireless reader to a researcher's computer.

The Med-ic ECM is designed to streamline clinical data collection. It also integrates IMC's CertiScan peripheral hardware and software with IT and packaging engineering support. The Med-ic™ ECM™ Package can be tailored for specific clinical requirements including monitoring temperature, vibration, humidity, light, radiation or shock to which the blister package has been exposed and recording the time of the exposure. Visual and auditory reminders, including LCDs, can also be integrated with the device as required. The Med-ic™ ECM™ Package uses a proprietary, disposable, nontoxic power cell and is environmentally safe. eCAP, a smart RFID closure for medication bottles and vials. It consists of the Med-ic RFID smart tag embedded in a Remind Cap bottle closure. Similar to the other packages, it reminds the patient when the next dose is due and records the time the patient opens the bottle to remove the tablet or capsule, logging compliance at that moment.

The recorded data are then retrieved with IMC's CertiScan reader for a physician or pharmacist to review.

### Medication Event Monitoring System (MEMS®)

The most successful microelectronic device primarily used in clinical trials is Aardex's MEMS device, a pill bottle with a cap that transmits data to a server, and reminds the patient to take his medicine.

The MEMS® measures and analyses the compliance of patients to prescribed drug regimens by: (a) collecting real time data on the patients monitor; (b) transferring the data from the monitor to a personal computer by means of a communicator; (c) storing the data in database; (d) displaying and printing reports of the results (tables and plots). Principal components of MEMS® system are (a) MEMS® monitor that collects real time data and store; (b) the data in a non-volatile internal storage unit; (c) a communicator that transfers the data from the monitor to a personal computer; (d) a computer program such as PowerView® that stores the data in a database calculates the results and displays or prints reports of these results.

In Intelligent Drug Administration System (IDAS), there are other devices primarily designed to regulate dosing that could be used to ensure patient's compliance. Some of these systems are disposable card-boxes, which can be up-loaded through a computer at the investigator site. Other strategies include reusable intelligent drug administration systems that accommodate blister strips. B&O Medicom has developed two such devices. Internally, they are referred as IDAS I and IDAS II respectively. The IDAS I is an electronic device with a multicolored diode display that serves as a reminder and even as a compliance indicator. The device registers every time the blister strip is taken out, signifying that a tablet/capsule has been swallowed. IDAS II device works with blister strips that have conductive lines printed on thin foil covering the plastic wells containing an active drug as tablet or capsule.

The blister strips are held in a monitor that is equipped with contact points for the conductive lines. A microprocessor sends electric current through the conductive lines at regular intervals and, when the patient takes a tablet/capsule from the pack, the foil and conductive lines are broken. This is registered in the microprocessor as a tablet has been taken. The information is stored in the blister monitor's memory. The dosing data are then loaded onto a PC or a server, enabling physicians and investigators to perform detailed analysis of each and every patient's dosing history, therapeutic coverage, and drug holiday and so on. IDAS, II also has audible and visual indicators to remind the patient to take their medication. Its LCD screen shows the time since last dose, actual time and a battery indicator.

An electronic “pill” dispenser (Medtime XL automatic medication dispenser/pill organizer/pill box, Med-Time XL) and reminder system helps to ensure that medications and vitamins are taken properly (pill identification) and on time. Med-Time XL is a device for dispensing medicine, reminding the user when medicine shall be taken, and making the correct dose available.

US Patent Application 2006/0079996 ('996)discloses a unit dose medication compliance monitoring and reporting apparatus and system that includes a dispenser shell formed with dose compartments. A retainer sheet affixed to the shell seals each compartment and partially bursts upon dispensing. A sensor network and monitoring and reporting circuitry records dispensing times and determines an average time interval, which can be reported with other data on an integral data display. The system can thereby monitor and report patient compliance with prescription regimens. Additional data can be recorded and displayed for augmented patient compliance assistance and analysis, which data can include customized informational messages, telephone and other patient support contact information, unit doses dispensed and remaining, reminder alarms, identification data, prescription regimens, among other data.

It should be understood that the apparatus disclosed in '996 is provides a limited number of medicament doses. The aforesaid number is defined by configuration of the dispenser shell and amounts to 10-20 medicament doses. The medicament doses for clinical trials should be prewrapped into the disclosed dispenser shells. It is worthy of note that the disclosed technical solution is sufficiently expensive. Thus, there is an unmet and long-felt need to provide a universal apparatus which is adapted for dispensing a predetermined number of medicaments to a predetermined plurality of patients with minimal expenses.

### SUMMARY OF THE INVENTION

It is hence one object of the invention to disclose a medicament dispensing device comprising (a) at least one container adapted for accommodating and dispensing at least one elongate packagible elongate blister pack carrying a plurality of blisters containing the medicament; (b) transporting means adapted for transporting the blister pack toward opening of the container; (c) dispensing means adapted for releasing a fragment of the blister pack bearing a predetermined number of the blisters from the container through the opening to a patient; and (d) controlling means adapted for identifying the patient before dispensing the blister to the patient, activating the dispensing means, recording actions of dispensing.

It is a core purpose of the invention to provide the substrate foldable and configured to be folded within the container. The dispensing means is adapted to cut off the blister bearing fragment.

Another object of the invention is to disclose the dispensing means adapted to cut off the blister bearing fragment such that the blisters remain intact.

A further object of the invention is to disclose the blister pack configured for folding in a manner selected from the group consisting of a concertina-like substrate, a serpentine-like substrate, a zig-zag-like substrate and any combination thereof.

A further object of the invention is to disclose the device adapted for monitoring patient compliance with a clinical trial protocol and a treatment program.

A further object of the invention is to disclose the controlling means adapted for performing at least one function selected from the group consisting of informing the patient about the clinical trial protocol, identifying the patient when arrived for taking the medication, recording actions of dispensing, transmitting obtained records to a clearing house and any combination thereof.

A further object of the invention is to disclose the device adapted for dispensing a number of medications concurrently and/or consecutively according to a treatment protocol.

A further object of the invention is to disclose the controlling means pre-programmable such that the controlling means broadcasts a message alerting the patient to take a predetermined dose of medicament accommodated in the blister according to the treatment protocol.

A further object of the invention is to disclose the device further comprising a mobile device configured to be carried by the patient. The mobile device is adapted for receiving the message.

A further object of the invention is to disclose the mobile device which is a bracelet carried by the patient.

A further object of the invention is to disclose the controlling means adapted for identifying patient by means of an RFID technology.

A further object of the invention is to disclose the transporting means comprising a guide member and a cogwheel. Cogs of the wheel are adapted for engaging with perforations located on the blister pack and linearly transporting the blister pack along the guide member.

A further object of the invention is to disclose the transporting means comprising a guide member and a wheel. The wheel adapted for tractably engaging with the blister pack and linearly transporting the blister pack along the guide member.

A further object of the invention is to disclose the dispensing means comprising a cutting knife. The knife is adapted for reciprocatively moving such that the knife cuts off the fragment of the blister pack carrying the predetermined number of the medicine doses. A further object of the invention is to disclose a packagible elongate blister pack adapted for bearing blisters accommodating medicament doses. The blister pack is configured for converting into a packaged configuration by means of multiply folding in a predetermined shape. The blister pack comprises a plurality of non-foldable portions bearing the at least one blister mechanically connected in series by means of foldable portions. The blisters are disposed on the foldable portions in a staggered arrangement so that when the blister pack is multiply folded. The blisters do not contact each other.

A further object of the invention is to disclose the predetermined shape of the foldable blister pack selected from the group consisting of a concertina-like shape, a serpentine-like shape, a zig-zag-like shape and any combination thereof.

A further object of the invention is to disclose the blister pack adapted for transporting thereof by means a cogwheel along a guide member. The blister pack has at least one line of perforations. The aforesaid line is directed in parallel to the blister pack. The perforations are adapted for engaging with cogs of the rotating cogwheel so that the blister pack is linearly transported along the guide member.

A further object of the invention is to disclose the foldable portion adapted to be cut off such that the fragment of the blister pack carrying the predetermined number of the medicine doses within the blisters borne by non-foldable portion are in a intact state.

A further object of the invention is to disclose a method of dispensing a medication. The aforesaid method comprises the steps of: (a) providing a medication dispensing device comprising: (i) at least one container adapted for accommodating and dispensing at least one elongate blister pack carrying a plurality of blisters containing the medicament; (ii) transporting means adapted for transporting the blister pack toward opening of the container; (iii) dispensing means adapted for releasing a fragment of the blister pack bearing a predetermined number of the blisters from the container through the opening to a patient; (iv) controlling means adapted for identifying the patient before dispensing the blister to the patient, activating the dispensing means, recording actions of dispensing; (b) providing at least one blister pack carrying a plurality of blisters accommodating medicament doses; (c) packaging the substrate; (d) loading the at least one substrate into the container; (e) identifying the patient when arrived; (f) dispensing the fragment of the blister pack.

It is a core purpose of the invention to provide the step of packaging comprising multiply folding the blister pack. The step of dispensing comprises cutting off the blister pack fragment carrying a predetermined number of the blisters.

A further object of the invention is to disclose the step of dispensing medication doses performed in intact blisters.

A further object of the invention is to disclose the method further comprising a step of monitoring patient compliance with clinical trial protocol and a treatment program.

A further object of the invention is to disclose the method further comprising steps of informing the patient about the clinical trial protocol, recording actions of dispensing and any combination thereof and transmitting obtained records to a clearing house.

A further object of the invention is to disclose the method further comprising a step of dispensing a number of medications performed concurrently and/or consecutively according to a treatment protocol.

A further object of the invention is to disclose the method further comprising a step of broadcasting a message enacting to take a corresponding dose of medicament according to the treatment protocol.

A further object of the invention is to disclose the method further comprising a step of receiving the message by a mobile device carried by the patient.

A further object of the invention is to disclose the step of receiving the message performed by bracelet carried by the patient.

A further object of the invention is to disclose the step of identifying the patient performed by means of an RFID technology.

A further object of the invention is to disclose the step of transporting the blister pack further comprising a sub-step of coming cogs of a cogwheel into perforations located on the blister pack and linearly transporting the substrate along the guide member.

A further object of the invention is to disclose the step of transporting dispensing medication comprising a sub-step of reciprocatively moving a cutting knife such that the knife cuts off the fragment of the blister pack carrying the predetermined number of the medicine doses and the blisters borne by non-foldable portion are in an intact state.

### BRIEF DESCRIPTION OF THE DRAWINGS

FIG. 1A is an upper view of the blister pack;

FIG. 1B is a side view of Option a blister pack;

FIG. 1C is a schematic view of the blister pack at step 1 of multiply folding;

FIG. 1D is a schematic view of the blister pack at step 2 of multiply folding;

FIG. 1E is a schematic view of the blister pack at step 3 of multiply folding;

FIG. 1F is a schematic view of the blister pack at step 4 of multiply folding;

FIG. 2 is an upper view of the first alternative embodiment of the blister pack;

FIG. 3A is an upper view of the second alternative embodiment of the blister pack;

FIG. 3B is a side view of the second alternative embodiment of the blister pack;

FIG. 4 is an upper view of the third alternative embodiment of the blister pack;

FIG. 5 is a kinematic scheme of the medicament dispensing device;

FIG. 6a is a front view of the medicament container;

FIG. 6b is a back view of the medicament container;

FIG. 7 is a schematic view of the medicament dispensing device;

FIG. 8 is a front view of the medicament dispensing device; and

FIG. 9 is an electric block scheme of the medicament dispensing device.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a device for drug distribution and a method of using thereof.

Clinical trials which constitute one of the essential and expensive stages in the continuous process of the medicines development are the critical stage in developing new medications. The clinical process phase is defined by the laws of different states and especially the FDA. The process includes a number of phases, in which the advance from one stage to another is possible only if the drug was proven efficacious in an earlier stage. The clinical trial management must execute the experiment according to protocols and the current standards (Good Clinical Practice—GCP). Every year thousand of clinical trials are conduced around the world, with the participation of hundreds in each trial. It is crucial to the pharmaceutical companies (sponsors) to reduce the time and costs of the trial to minimum possible, mainly by (a) obtaining a full and real knowledge of the participant's compliance & adherence to the trials protocols; (b) increasing participant's compliance & adherence to the given medicament; (c) minimizing the duration of the clinical trial period to a minimum; and (d) minimizing medication packaging and distribution costs.

In accordance with the current invention, a portable personal computerized device, designated for controlling, timing and supervision the dispensing of medicament to participants in clinical trials is disclosed.

The system is adapted to dispense a number of different medicines together or separately according to treatment program (timetable/protocol) and in doses determined by a manager of the clinical trial. Additionally, the system is adapted for providing the patient with instructions about a manner of using the medicaments.

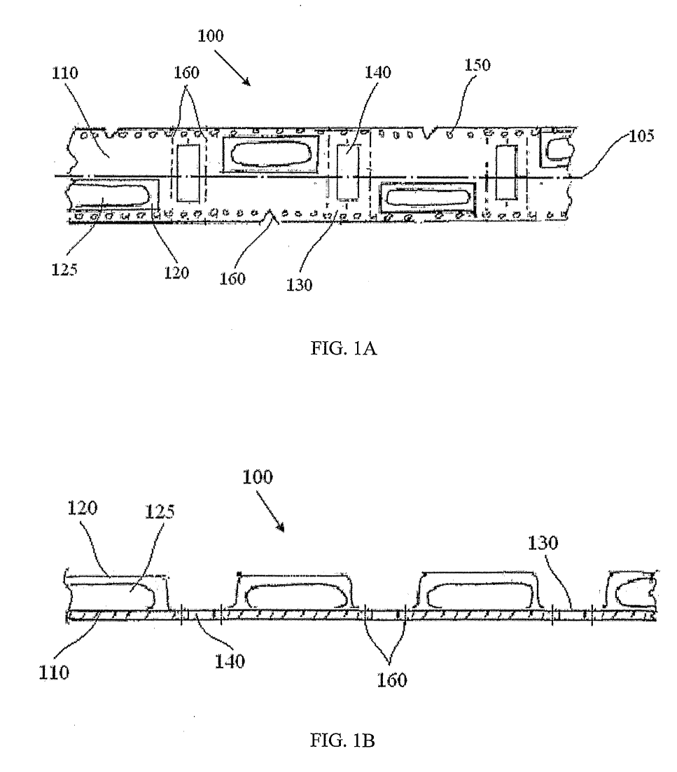

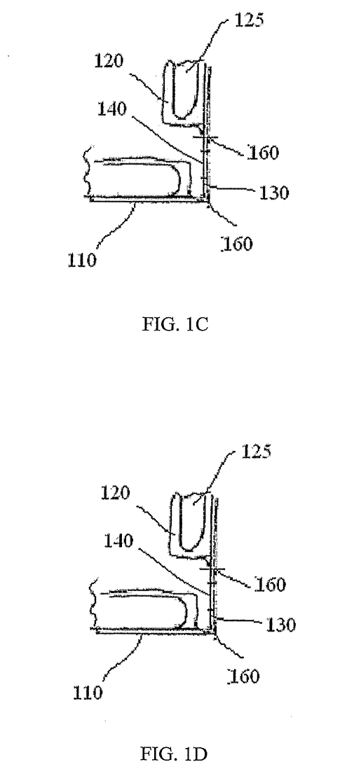

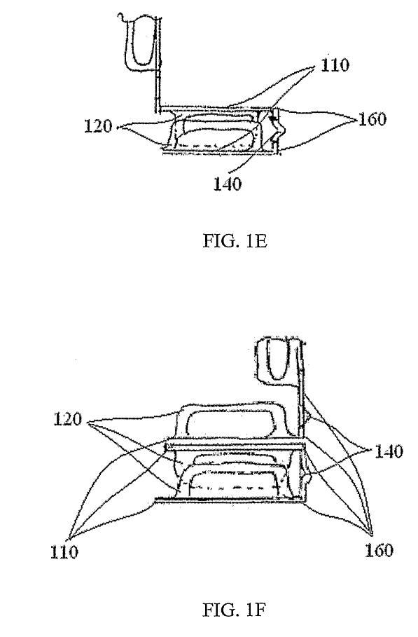

Reference is now made to FIGS. 1a and 1b, showing an elongate blister pack 100. The aforesaid pack comprises non-foldable portions 110 bearing blisters 120 accommodating medicament doses 125 and foldable portions 130 having openings 140. The blisters 120 are disposed asymmetrically relative to a pack axis 105 so that so that when the blister pack 100 is multiply folded, the blisters 120 do not contact each other. The blister pack 100 is provide with indents 160 adapted for fixing thereof in a moment of cutting off a predetermined fragment in a dispensing device (not shown). Perforations 150 punctured along lateral edges are designed for transporting the blister pack from a container (not shown).

Reference is now made to FIGS. 1c-1f, presenting stages of folding the blister pack 100 in a serpentine manner. It should be emphasized that proposed folding procedure provides space saving because sides of the non-foldable portions 110 bearing the blisters 120 are faced each other at a distance equal to a blister height, while opposite sides are adjacent with each other.

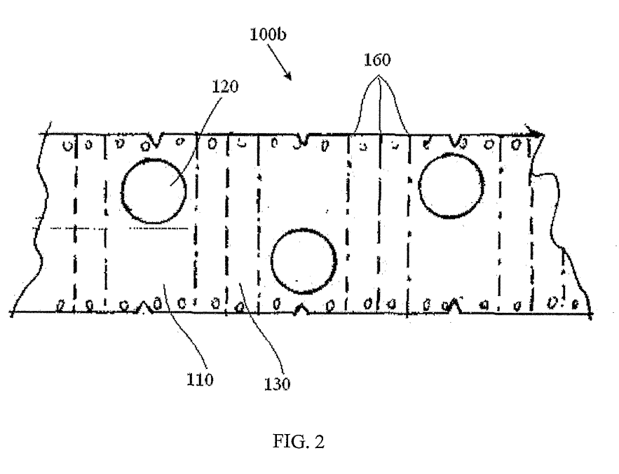

Reference is now made to FIG. 2, showing an embodiment 100b. The blister pack 100b is adapted for packaging medicament doses configured as a ball, a drop or any similar shape.

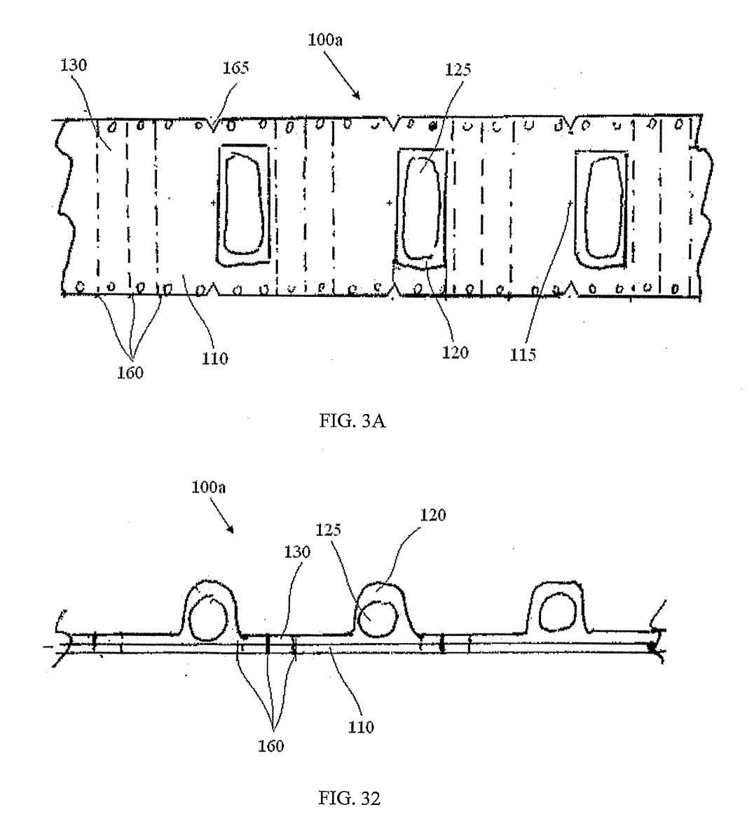

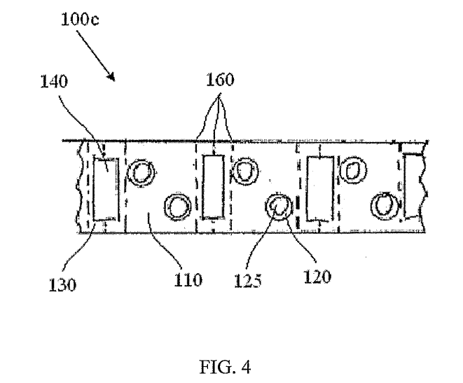

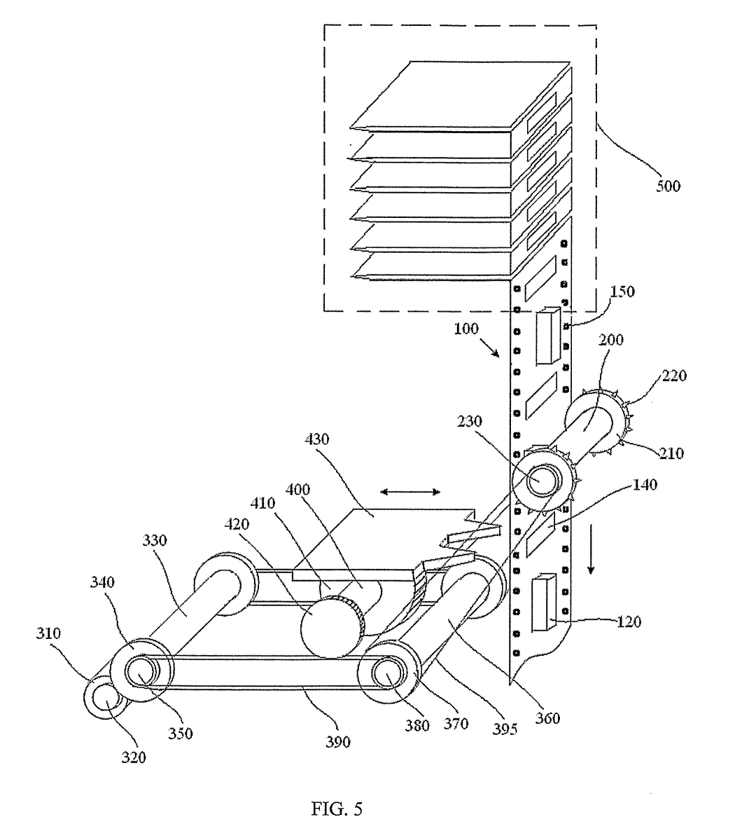

Reference is now made to FIGS. 3a and 3b, presenting an alternative embodiment of the current invention 100a. The blister pack 100a is characterized by laterally disposing the blister 120 with a constant longitudinal shift relative to a geometrical center 115. When the blister pack 100 is multiply folded, the blisters 120 do not contact each other. Reference is now made to FIG. 4, showing an embodiment 100c characterized by both lateral and longitudinal shift from the pack axis and geometrical center, respectively. It should be appreciated that the disclosed configuration provides space saving due to folding the blister pack 100c so that the blisters 120 do not contact each other. Reference is now made to FIG. 5, schematically presenting a mechanical scheme of the disclosed medicament dispensing device. The device is powered by an electric motor 310 provided with a gear wheel 320 mechanically connected to a motor shaft (not shown). The wheel 320 is engaged with a wheel 340 which is a part of a wheel pair 330. A pulley 350 transmits a torque from to a pulley 380 which is mechanically connected to a wheel pair 360. Further, the torque is transmitted from wheel 370 to a pulley 230. As shown in FIG. 5, the wheel pairs are interconnected by a notched belt 390 engaged with a gear wheel 410. The gear assembly 400 includes the driving wheels 420 and a driven wheel 410. The aforesaid driven wheel 210 is engaged with a knife 430 adapted for cutting of a predetermined fragment of the blister pack 100 due to reciprocative motion along tracks (not shown). It should be emphasized that the driving wheel 420 is in a reversible engagement with a notched belt 390 so that the rotational torque is transmitted from the electric motor 310 discretely.

A wheel pair 200 driven by the pulley 230 is adapted for dragging the blister pack 100 along tracks (not shown). Wheels 210 are provided with cogs 220 which adapted for engaging with perforations 140. The rotating wheels 210 provide dragging the blister pack according to an arrow downward.

The mechanical part of the medicament dispensing device operated as follows. The wheel pair 200 drags out a predetermined fragment of the blister pack 100 from the container 500 where the aforesaid blister pack 100 is in a multiply folded state. Further the knife 430 cuts out the predetermined fragment which is released to the patient.

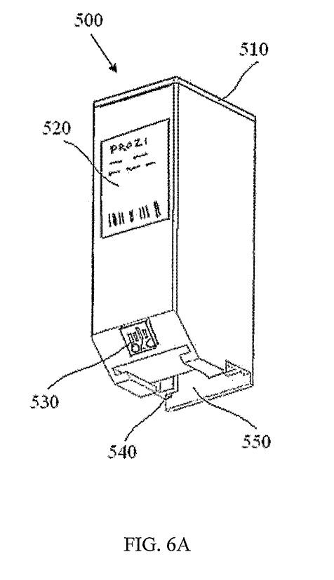

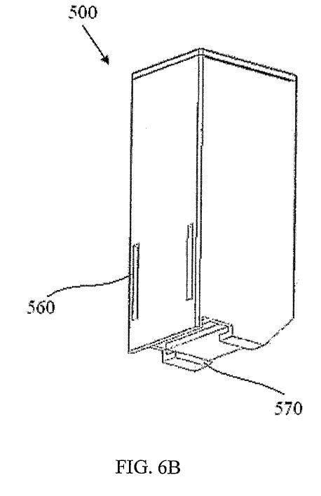

Reference is now made to FIGS. 6a and 6b, presenting an outside appearance of the container 500. An access into the container is provided by a top cover 510. On a front face of the container there are an identification mark 520 and electronic circuit 530. A dispensing slot 550 provided with tracks 540 and knife tracks 570 are on the underside of the container 500. Anchor slots are on the back side.

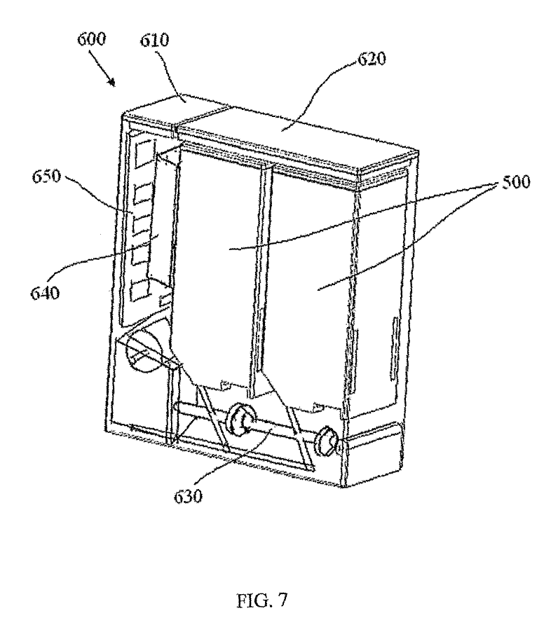

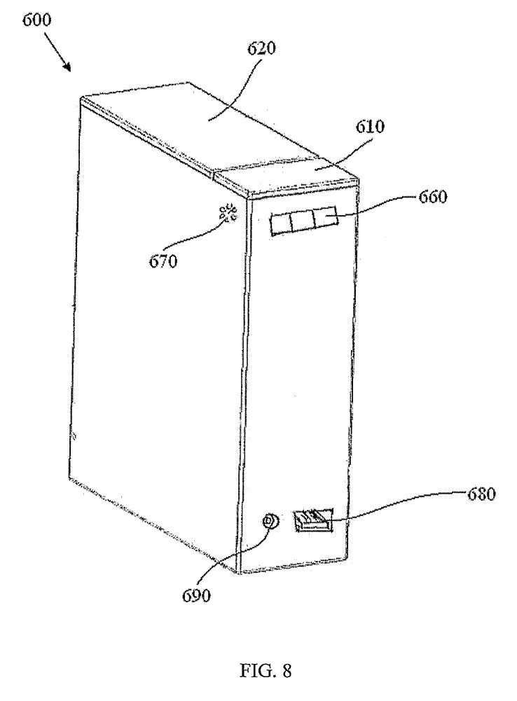

Reference is now made to FIG. 7, showing a further embodiment of the current invention. The medicament dispensing device 600 comprises a number of containers 500 (two containers are shown in FIG. 7 in a non-limiting manner), a lever cutting mechanism 630, central electrical unit 650 and cellular communication unit (GSM) containing a SIM 640. Reference is now made to FIG. 8, showing a further embodiment of the current invention. The medicament dispensing device 600 has on the outer surface following elements: a slot for changing the containers 620, an electrical unit slot 610, USB connectors 680 for transferring data between the system and an external computer, an electrical outlet 690 for an external power unit, slots for Sound System 670, 3 control indicators for the following states: Working, Failure, Standby 660.

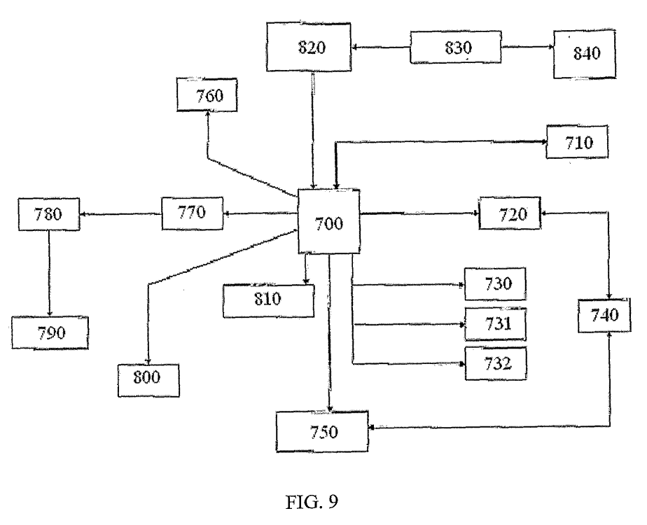

Reference is now made for FIG. 9, presenting an electrical circuit of medicament dispensing device which the following components: CPU 700, a memory chip 720, MP3 for broadcasting warnings 810, a control unit responsible for releasing the pills 770, an RFID identification system 760, a cellular communication unit (GSM) containing a SIM 820, a backup system 740, a central clock 750. The CPU 700 receives the time from the central clock 750 and the treatment schedule recorded on the pill container's chip (not shown). When the time for dispensing the pills arrives, the system sends an audible signal using the MP3 810 and/or the special bracelet on the patient's hand.

The system identifies the patient with the help of the RFID 760; after the identification, the system activates the pill dispenser and the appropriate pills are released into the container. After the patient takes the pills, the system sends an SMS to the central management facility of the Clinical Trial using the communication unit 820. If the patient did not take the medication, the system activates a warning process as explained below. The patient can select from among a number of ring tones; when the time for taking the medication arrives, the system activates the tone a number of times and/or activates a special system that sends a signal to the bracelet on the patient's hand causing it to vibrate.

When a signal corresponding to a time of medicament releasing is received, the RFID system is activated, sends a search signal and waits for the patient to answer. The patient brings the RFID tag that he is wearing close to the system and when identification is made, the system sends a signal to the main processor 700 to start the process of releasing a pill from the container. If the patient is not identified within a certain time period, the system activates a “late process” and patient reminder.

If the patient does not identify himself after receiving the signal and does not remove the medication from the container, the system sends an audible signal (ring tone) after 30 minutes. If the patient does not take the medication, the system sends an SMS to the patient's telephone to remind him. If after 120 minutes the identification activity has still not been executed, or a pill taken out, the system sends an SMS to the central management of the clinical trials.

The controller 770 receives the command from the CPU 700 to release the pill from a certain container. The controller activates the electric motor 780 that causes the container's dispenser to move.

When the pill is in place, the cutting mechanism is activated at the designated cutting line. If the pill gets stuck for any reason, the system sends an SMS to the central clinical supply.

When it is necessary to send an SMS, the system receives the number of the message that it must send. The CPU 700 finds the message and phone number that is needed to send the message, from the system memory 720.

The system activates the communication system 820 that dials and sends the message. The system calculates the number of pills that remain in the container. When the number reaches 5 or less, the system sends messages to the user and to the clinical trial center, warning that the container will be finished. After the container is emptied, a similar message is sent. Simultaneously, the date and time when the container becomes empty is written to the container's memory. When the container is replaced the system writes the required information (day, hour, number of patient, number of container, etc.) to the CHIP on the container.

In accordance with one embodiment of the current invention, a medicament dispensing device comprises (a) at least one container adapted for accommodating and dispensing at least one elongate packagible elongate blister pack carrying a plurality of blisters containing the medicament; (b) transporting means adapted for transporting the blister pack toward opening of the container; (c) dispensing means adapted for releasing a fragment of the blister pack bearing a predetermined number of the blisters from the container through the opening to a patient; and (d) controlling means adapted for identifying the patient before dispensing the blister to the patient, activating the dispensing means, recording actions of dispensing.

It is a core feature of the current invention to provide the substrate foldable and configured to be folded within the container. The dispensing means is adapted to cut off the blister bearing fragment.

In accordance with another embodiment of the current invention, the dispensing means is adapted to cut off the blister bearing fragment such that the blisters remain intact.

In accordance with a further embodiment of the current invention, the blister pack is configured for folding in a manner selected from the group consisting of a concertina-like substrate, a serpentine-like substrate, a zig-zag-like substrate and any combination thereof.

In accordance with a further embodiment of the current invention, the device is adapted for monitoring patient compliance with a clinical trial protocol and a treatment program. In accordance with a further embodiment of the current invention, the controlling means is adapted for performing at least one function selected from the group consisting of informing the patient about the clinical trial protocol, identifying the patient when arrived for taking the medication, recording actions of dispensing, transmitting obtained records to a clearing house and any combination thereof.

In accordance with a further embodiment of the current invention, the device is adapted for dispensing a number of medications concurrently and/or consecutively according to a treatment protocol.

In accordance with a further embodiment of the current invention, the controlling means is pre-programmable such that the controlling means broadcasts a message alerting the patient to take a predetermined dose of medicament accommodated in the blister according to the treatment protocol.

In accordance with a further embodiment of the current invention, the device further comprises a mobile device configured to be carried by the patient. The mobile device is adapted for receiving the message.

In accordance with a further embodiment of the current invention, the mobile device is a bracelet carried by the patient.

In accordance with a further embodiment of the current invention, the controlling means is adapted for identifying patient by means of an RFID technology.

In accordance with a further embodiment of the current invention, the transporting means comprises a guide member and a cogwheel. Cogs of the wheel are adapted for engaging with perforations located on the blister pack and linearly transporting the blister pack along the guide member.

In accordance with a further embodiment of the current invention, the transporting means comprises a guide member and a wheel. The wheel adapted for tractably engaging with the blister pack and linearly transporting the blister pack along the guide member.

In accordance with a further embodiment of the current invention, the dispensing means comprises a cutting knife. The knife is adapted for reciprocatively moving such that the knife cuts off the fragment of the blister pack carrying the predetermined number of the medicine doses.

In accordance with a further embodiment of the current invention, a packagible elongate blister pack is adapted for bearing blisters accommodating medicament doses. The blister pack is configured for converting into a packaged configuration by means of multiply folding in a predetermined shape. The blister pack comprises a plurality of non-foldable portions bearing the at least one blister mechanically connected in series by means of foldable portions. The blisters are disposed on the foldable portions in a staggered arrangement so that when the blister pack is multiply folded. The blisters do not contact each other.

In accordance with a further embodiment of the current invention, the predetermined shape of the foldable blister pack is selected from the group consisting of a concertina-like shape, a serpentine-like shape, a zig-zag-like shape and any combination thereof.

In accordance with a further embodiment of the current invention, the blister pack is adapted for transporting thereof by means a cogwheel along a guide member. The blister pack has at least one line of perforations. The aforesaid line is directed in parallel to the blister pack. The perforations are adapted for engaging with cogs of the rotating cogwheel so that the blister pack is linearly transported along the guide member.

In accordance with a further embodiment of the current invention, the foldable portion is adapted to be cut off such that the fragment of the blister pack carrying the predetermined number of the medicine doses within the blisters borne by non-foldable portion are in a intact state.

In accordance with a further embodiment of the current invention, a method of dispensing a medication is disclosed. The aforesaid method comprises the steps of (a) providing a medication dispensing device comprising: (i) at least one container adapted for accommodating and dispensing at least one elongate blister pack carrying a plurality of blisters containing the medicament; (ii) transporting means adapted for transporting the blister pack toward opening of the container; (iii) dispensing means adapted for releasing a fragment of the blister pack bearing a predetermined number of the blisters from the container through the opening to a patient; (iv) controlling means adapted for identifying the patient before dispensing the blister to the patient, activating the dispensing means, recording actions of dispensing; (b) providing at least one blister pack carrying a plurality of blisters accommodating medicament doses; (c) packaging the substrate; (d) loading the at least one substrate into the container; (e) identifying the patient when arrived; (f) dispensing the fragment of the blister pack.

It is a core feature of the invention to provide the step of packaging comprising multiply folding the blister pack. The step of dispensing comprises cutting off the blister pack fragment carrying a predetermined number of the blisters.

In accordance with a further embodiment of the current invention, the step of dispensing medication doses is performed in intact blisters.

In accordance with a further embodiment of the current invention, the method further comprises a step of monitoring patient compliance with clinical trial protocol and a treatment program.

In accordance with a further embodiment of the current invention, the method further comprises steps of informing the patient about the clinical trial protocol, recording actions of dispensing and any combination thereof and transmitting obtained records to a clearing house.

In accordance with a further embodiment of the current invention, the method further comprises a step of dispensing a number of medications performed concurrently and/or consecutively according to a treatment protocol.

In accordance with a further embodiment of the current invention, the method further comprises a step of broadcasting a message enacting to take a corresponding dose of medicament according to the treatment protocol.

In accordance with a further embodiment of the current invention, the method further comprises a step of receiving the message by a mobile device carried by the patient.

In accordance with a further embodiment of the current invention, the step of receiving the message is performed by bracelet carried by the patient.

In accordance with a further embodiment of the current invention, the step of identifying the patient is performed by means of an RFID technology.

In accordance with a further embodiment of the current invention, the step of transporting the blister pack further comprises a sub-step of coming cogs of a cogwheel into perforations located on the blister pack and linearly transporting the substrate along the guide member.

In accordance with a further embodiment of the current invention, the step of transporting dispensing medication comprises a sub-step of reciprocatively moving a cutting knife such that the knife cuts off the fragment of the blister pack carrying the predetermined number of the medicine doses and the blisters borne by non-foldable portion are in an intact state.

1-28. (canceled)

29. A medicament dispensing device comprising:
(a) at least one container adapted for accommodating and dispensing at least one elongate packagible blister pack carrying a plurality of blisters, each of which is adapted to contain said medicament; said blister pack is characterized by a folded portions 130 and a non folded portions 110; said pack is foldable and configured to be folded within said container; each of said non folded portions 110 comprises at least one blister-occupied position, in which a blister is disposed; and at least one blister-empty position;
(b) transporting means adapted for transporting said blister pack toward opening of said container;
(c) dispensing means adapted for cutting a fragment of said blister pack bearing a predetermined number of said blisters and releasing said fragment from said container through said opening to a patient;
(d) controlling means adapted for identifying said patient before dispensing said blister to said patient, activating said dispensing means, recording actions of dispensing;
the disposition of said blisters in said non folded portions 110 is characterized by an arrangement in which each blister-empty position in a non folded portion is a blister-occupied position in the two neighboring non folded portions so that when said blister pack is multiply folded, said blisters do not contact each other.

30. The device according to claim 29, wherein said dispensing means is adapted to cut off said blister bearing fragment such that said blisters remain intact; further wherein said dispensing means comprises a cutting knife; said knife is adapted for reciprocatively moving such that said knife cuts off said fragment of said blister pack carrying said predetermined number of said medicine doses.

31. The device according to claim 29, wherein said blister pack is configured for folding in a manner selected from the group consisting of a concertina-like substrate, a serpentine-like substrate, a zig-zag-like substrate and any combination thereof.

32. The device according to claim 29, adapted for monitoring patient compliance with a clinical trial protocol and a treatment program.

33. The device according to claim 29, wherein said controlling means is adapted for performing at least one function selected from the group consisting of informing said patient about said clinical trial protocol, identifying said patient when arrived for taking said medication, recording actions of dispensing, transmitting obtained records to a clearing house and any combination thereof.

34. The device according to claim 29, adapted for dispensing a number of medications concurrently and/or consecutively according to a treatment protocol.

35. The device according to claim 29, wherein said controlling means is pre-programmable such that said controlling means broadcasts a message alerting said patient to take a predetermined dose of medicament accommodated in said blister according to said treatment protocol.

36. The device according to claim 35, further comprising a mobile device configured to be carried by said patient; said mobile device is adapted for receiving said message.

37. The device according to claim 29, wherein said mobile device is a bracelet carried by said patient.

38. The device according to claim 29, wherein said controlling means is adapted for identifying said patient by means of an RFID technology.
The device according to claim 29, wherein said transporting means comprises at least one selected from a group consisting of (a) a guide member and a cogwheel, cogs of said wheel are adapted for engaging with perforations located on said blister pack and linearly transporting said blister pack along said guide member (b) a guide member and a wheel, said wheel adapted for tractably engaging with said blister pack and linearly transporting said blister pack along said guide member.

39. A packagible elongate blister pack adapted for bearing blisters accommodating medicament doses; said blister pack configured for converting into a packaged configuration by means of multiply folding in a predetermined shape; said blister pack comprising a plurality of non-foldable portions bearing said at least one blister mechanically connected in series by means of foldable portions; each of said non folded portions 110 comprises at least one blister-occupied position, in which a blister is disposed; and at least one blister-empty position; the disposition of said blisters in said non folded portions 110 is characterized by an arrangement in which each blister-empty position in a non folded portion is a blister-occupied position in the two neighboring non folded portions so that when said blister pack is multiply folded, said blisters do not contact each other.

40. The blister pack according to claim 39, wherein said predetermined shape of said foldable blister pack is selected from the group consisting of a concertina-like shape, a serpentine-like shape, a zig-zag-like shape and any combination thereof.

41. The blister pack according to claim 39, adapted for transporting thereof by means a cogwheel along a guide member; said blister pack having at least one line of perforations; said line is directed in parallel to said blister pack; said perforations are adapted for engaging with cogs of said rotating cogwheel so that said blister pack is linearly transported along said guide member.

42. The blister pack according to claim 39, wherein said foldable portion is adapted to be cut off such that said fragment of said blister pack carrying said predetermined number of said medicine doses within said blisters borne by non-foldable portion are in a intact state.

43. A method of dispensing a medication; said method comprising the steps of:
(a) providing a medication dispensing device comprising:
i. at least one container adapted for accommodating and dispensing at least one elongate blister pack carrying a plurality of blisters containing said medicament;
ii. transporting means adapted for transporting said blister pack toward opening of said container;
iii. dispensing means adapted for cutting a fragment of said blister pack bearing a predetermined number of said blisters and releasing said fragment from said container through said opening to a patient;
iv. controlling means adapted for identifying said patient before dispensing said blister to said patient, activating said dispensing means, recording actions of dispensing;
(b) providing at least one blister pack carrying a plurality of blisters accommodating medicament doses; said blister pack is characterized by a folded portions 130 and a non folded portions 110; each of said non folded portions 110 comprises at least one blister-occupied position, in which a blister is disposed; and at least one blister-empty position
(c) packaging said blister pack by multiply folding said blister pack in a zig-zag-like form;
(d) loading said at least one blister pack into said container;
(e) identifying said patient when arrived;
(f) dispensing said fragment of said blister pack;
wherein said step of providing at least one blister pack carrying a plurality of blisters accommodating medicament doses is characterized by the disposition of said blisters in said non folded portions 110 in a predetermined arrangement in which each blister-empty position in a non folded portion is a blister-occupied position in the two neighboring non folded portions so that when said blister pack is multiply folded, said blisters do not contact each other.

44. The method according to claim 43, wherein said step of dispensing medication doses is performed in intact blisters.

45. The method according to claim 43, further comprising a step of monitoring patient compliance with a clinical trial protocol and a treatment program.

46. The method according to claim 43, further comprising steps of informing said patient about said clinical trial protocol, recording actions of dispensing and any combination thereof and transmitting obtained records to a clearing house.

47. The method according to claim 43, further comprising a step of dispensing a number of medications performed concurrently and/or consecutively according to a treatment protocol.

48. The method according to claim 43, further comprising at least one step selected form a group consisting of (a) broadcasting a message enacting to take a corresponding dose of medicament according to said treatment protocol; (b) receiving said message by a mobile device carried by said patient; (c) receiving said message is performed by bracelet carried by said patient; or any combination thereof.

49. The method according to claim 43, wherein said step of identifying said patient is performed by means of an RFID technology.

50. The method according to claim 43, wherein said step of transporting said blister pack further comprises coming cogs of a cogwheel into perforations located on said blister pack and linearly transporting said substrate along said guide member.

51. The method according to claim 43, wherein said step of transporting dispensing said medication comprises reciprocatively moving a cutting knife such that said knife cuts off said fragment of said blister pack carrying said predetermined number of said medicine doses and said blisters borne by non-foldable portion are in an intact state.
